(19) United States
(12) Patent Application Publication
(10) Pub. No.: US 2008/0282616 A1
(43) Pub. Date: Nov. 20, 2008

(54) DOOR WEATHER STRIP

(75) Inventors: Tomofumi EGUCHI, Hiroshima-shi (JP); Toshifumi Matsuura, Hatsukaichi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NISHIKAW A RUBBER CO., LTD., Hiroshima-shi (JP)

(21) Appl. No.: 12/104,157

(22) Filed: Apr. 16, 2008

(30) Foreign Application Priority Data
May 16, 2007 (JP) JP2007-129983

(51) Int. Cl. E06B 7/16

(52) U.S. Cl. 49/489.1

(57) ABSTRACT

A door weather strip 10 is mounted on a roof side of a door sash 11 of an automobile, said door sash 11 including: an outer surface 11A; a first mounting member 11B having an anchoring part 11Ba formed thereon; and a second mounting member 11C, wherein: said door weather strip 10 comprises: an outer lip 1 extending upward on an outer-cabin side of said door, of which an upper part makes an elastic contact with a body panel 13 and a base root 1a is positioned higher than said first mounting member 11B; a hollow seal member 2 mounted on an inner-cabin side compared with the outer lip 1 via a connecting member 3 by means of a clip 14 and which makes an elastic contact with said body panel 13; a rear lip 4 provided at a lower position of the outer lip 1 and which make an elastic contact with said first mounting member 1B; a hook 5 provided at a lower position of the connecting member 3 and engaging with an anchoring part 11Ba; and a seal lip 6 provided under said hook 5 and which makes an elastic contact with the second mounting member 11C; and wherein a gap 60 is provided between an outer-cabin side surface of the base root 1a of said outer lip 1 and the rear lip 4, where said outer lip 1 along the base root 1a can bend toward the outer-cabin side at the time of the elastic contact.

### BACKGROUND OF THE INVENTION

The present invention relates to a mounting structure of a door weather strip mounted on a roof side of a door sash of an automobile by means of a clip, which makes an elastic contact with a body panel and seals an aperture between a door and the body panel.

Examples of an ordinary door weather strip mounted on the door sash of the automobile and which make the elastic contact with the body panel include a door weather strip fixed on the roof side of the door sash by means of the clip.

As shown in FIGS. 3 to 5, a door weather strip 20 includes: an outer lip 21 fastened by a body panel 13 and a sash molding 12 (or a door sash 11) respectively from an upper and a lower side; a hollow seal member 2 positioned on an inner-cabin side compared with the outer lip 21; and a connecting member 25 connecting the outer lip 21 and the hollow seal member 2.

A door sash 11 includes: an outer surface 11A vertically provided on an outer-cabin side of an upper part of a door; a first mounting member 11B laterally provided roughly from an upper end of the outer surface 11A toward the inner-cabin side and having a downward anchoring part 11Ba formed on an inner-cabin side end thereof, and a second mounting member 11C positioned lower than the first mounting member 11B and laterally provided from the outer-cabin side toward the inner-cabin side.

The door weather strip 20 is mounted on the door sash 11 by fixing a base bottom portion 2a of the hollow seal member 2 on the inner-cabin side circumference surface of the second mounting member 11C of the door sash 11 by means of the clip 14 while engaging a hook 22 integrally molded with a lower part of the connecting member 25 with the anchoring part 11Ba formed on the first mounting member 11B of the door sash 11 so as to increase assembling force of the door weather strip 20 with the door sash 11.

In addition, an elastic contact made between a top end of a seal lip 23 integrally molded with a base root of the hook 22 in a downward direction and the second mounting member 11C increases sealing property. The seal lip 23 is formed diagonally toward the inner-cabin side in order to supplement the assembling force of the hook 22 with the anchoring part 11Ba.

The outer lip 21 is made of soft material in consideration of door-closing property as well as high rigidity of a base root of the outer lip 21, required for controlling generation of noise during driving an automobile.

The Japanese unexamined Patent Publication No. H09-300965 discloses a method of increasing the assembling force of the door weather strip with the door sash, said door weather strip being fit and assembled on a cross section roughly concave shaped retainer.

The door weather strip 20 according to a prior art however has the following problems to be solved.

(1) Since the outer lip 21 is formed of the soft material and the base root 21a of the outer lip 21 is mounted on the sash molding 12 (the door sash 11 if the sash molding 12 is not provided) in such a manner that the base root 21a of the outer lip 21 abuts on the sash molding 12 (or the door sash 11), the outer lip 21 is wrinkled and degraded in external appearance when the outer lip 21 is fastened between the sash molding 12 (or the door sash 11) and the body panel 13 respectively from an upper and a lower side.

(2) Formation of the hook 22 of the soft material in the same manner as the outer lip 21 results in insufficient assembling force of the hook 22 with the anchoring part 11Ba of the first mounting member 11B, thereby degrading assembling workability.

(3) Inclination of the seal lip 23 toward the inner-cabin side lures water 80 entering from the outside of the automobile into the inner-cabin side, which results in deterioration in sealing property. As shown in FIG. 6, such a deterioration in sealing property is caused by a space 70 between a bottom end of the seal lip 23 and the second mounting member 11C where water 80 entering from a space between the base root 21a of the outer lip 21 and the door sash 11 via a space between the hook 22 and the door sash 11 stagnates for the effect of surface tension.

The door weather strip disclosed in the Japanese unexamined Patent Publication No. H09-300965, which is fit and assembled on a cross-section roughly U-shaped retainer differs from the door weather strip 20 in structure shown in FIG. 4, which is mounted on the door sash 11 by means of the clip 14 and has the outer lip 21 and the hollow seal member 2 connected by the connecting member 25.

Therefore, an object of the present invention is to provide the door weather strip mounted on the roof side of the door sash by means of the clip, which is excellent in assembling workability and the sealing property as well as external appearance of the outer lip.

### SUMMARY OF THE INVENTION

In order to achieve the above-mentioned object, a first aspect of the invention provides a door weather strip (10) mounted on a roof side of a door sash (11) of an automobile, said door sash (11) including: an outer surface (11A) vertically provided on an outer-cabin side of an upper part of a door; a first mounting member (11B) laterally provided roughly from an upper end of the outer surface (11A) toward an inner-cabin side and having a downward anchoring part (11Ba) formed on an inner-cabin side end thereof, and a second mounting member (11C) positioned lower than the first mounting member (11B) and laterally provided from the outer-cabin side toward the inner-cabin side, wherein:

said door weather strip (10) comprises: an outer lip (1) extending upward on the outer-cabin side of said door, of which an upper part makes an elastic contact with a body panel (13) of said automobile and a lower part as a base root (1a) is positioned higher than said first mounting member (11B); a hollow seal member (2) arranged on the inner-cabin side compared with the outer lip (1), of which a base bottom portion (2a) is mounted on the inner-cabin side of said second mounting member (11C) by means of a clip (14) and an upper part makes an elastic contact with said body panel (13); a connecting member (3) connecting said outer lip (1) and said hollow seal member (2); a rear lip (4) provided at a lower position than the base root (1a) of the outer lip (1) and extending toward the outer-cabin side so as to make an elastic contact with an upper surface of a laterally provided part of said first mounting member (11B); a hook (5) provided at a lower position of the connecting member (3) and engaging with the anchoring part (11Ba) of the first mounting member (11B) from a lower side; a seal lip (6) provided downward from a base root (5a) of said hook (5) and of which a top end (6a) makes an elastic contact with the outer-cabin side of the second mounting member (11C); and wherein a gap (60) is provided between an outer-cabin side surface of the base root (1a) of said outer lip (1) and said rear lip (4), where said outer lip (1) along the base root (1a) can bend toward the outer-cabin side at the time of the elastic contact.

A second aspect of the invention provides a door weather strip (10), wherein said gap (60) is the size sufficient for preventing the outer-cabin side surface of said outer lip (1) from coming into contact with a member (11 or 12) on said door side at the time of said elastic contact.

A third aspect of the invention provides a door weather strip (10), wherein said member on said door side is either said door sash (11) or a sash molding (12) mounted on the outer surface (11A) of said door sash (11).

A fourth aspect of the invention provides a door weather strip (10), wherein said hook (5) is made of harder material than any other member of the door weather strip (10).

A fifth aspect of the invention provides a door weather strip (10), wherein said seal lip (6) is provided diagonally downward toward the outer-cabin side.

A sixth aspect of the invention provides a door weather strip (10), wherein said rear lip (4) is provided diagonally downward toward the outer-cabin side and said seal lip (6) is roughly in parallel with said rear lip (4).

Symbols in parentheses show constituents or items corresponding to Figures and DESCRIPTION OF PREFERRED EMBODIMENT.

According to the door weather strip according to the first aspect of the present invention, formation of the gap between the outer-cabin side surface of the base root of said outer lip and the rear lip, where said outer lip along the base root can bend toward the outer-cabin side at the time of the elastic contact prevents wrinkles on the outer lip, thereby enabling to provide a product excellent in external appearance of the outer lip.

Specifically, the body panel and the door sash fasten the outer lip respectively from an upper and a lower side at the time of closing the door, thereby generating compression force. The compression force is absorbed by the gap where the outer lip along the base root can bend toward the outer-cabin side, therefore the outer lip is not wrinkled and is improved in external appearance.

In addition, the structure that the base root of the outer lip is positioned higher than the door sash via the rear lip and the gap thus provided prevents bottom-abutting of the outer lip, an example of which is that the base root of the outer lip directly abuts on the door sash, thereby preventing load on the outer lip from increasing. Therefore, the outer lip is not necessarily made of soft material and any material which is not wrinkled and excellent in the external appearance is usable for it.

Further, formation of the rear lip prevents entrance of water from a space between the door sash and the base root of the outer lip, thereby improving sealing property.

According to the door weather strip according to the second and third aspects of the present invention, the gap thus provided is the size sufficient for preventing the outer-cabin side surface of said outer lip from coming into contact with the member on the door side such as the door sash or the sash molding mounted on the outer surface of the door sash. Such a structure effectively prevents increase in load on the outer lip.

According to the door weather strip according to the fourth aspect of the present invention, the hook provided at a lower position of the connecting member in order to engage with the anchoring part formed on the door sash from a lower side is made of harder material than any other member of the door weather strip so as to be increased in rigidity.

Such a hook increased in rigidity is also increased in assembling force with the anchoring part, thereby improving mounting workability of the door weather strip.

According to the door weather strip according to the fifth aspect of the present invention, the seal lip is provided diagonally downward toward the outer-cabin side so that the sealing property of the space between the seal lip and the door sash is improved.

Said effect is attained by providing the seal lip toward the outer-cabin side which is opposite to the direction in which water enters so that the space does not occur between the top end of the seal lip and the door sash, where water stagnates for the effect of surface tension. In addition, since the space does not occur, water entering from the outer-cabin side is smoothly released along the longitudinal direction of the seal lip.

According to the door weather strip according to the sixth aspect of the present invention, providing the rear lip diagonally downward toward the outer-cabin side and said seal lip roughly in parallel with said rear lip prevents reversal of the seal lip, which occurs when mounting the door weather strip on the door sash, thereby further improving mounting workability of the door weather strip.

More specifically, the door weather strip is mounted on the door sash while being moved in the direction of an arrow 90 shown in FIG. 2. The use of a seal lip not in parallel with the rear lip, an example of which is a seal lip turning toward the inner-cabin side prevents smooth movement of the top end of the seal lip on the surface of the door sash and causes reversal of the top end of the seal lip toward the inner-cabin side. Such a reversal causes complex mounting of the door weather strip and degrades mounting workability whereas the seal lip roughly in parallel with said rear lip solves said problems.

### BRIEF DESCRIPTION OF THE DRAWINGS

FIG. 1 is a I-I line enlarged cross section of FIG. 3, showing a door weather strip according to an embodiment of the present invention;

FIG. 2 is a partial enlarged cross section of important parts of the door weather strip shown in FIG. 1;

FIG. 3 is a lateral view of an automobile having the door weather strip mounted thereon;

FIG. 4 is a I-I line enlarged cross section of FIG. 3, showing a door weather strip according to a prior art;

FIG. 5 is a partial enlarged cross section of important parts of the door weather strip shown in FIG. 4; and

FIG. 6 is partial enlarged cross section showing entrance of water to the door weather strip shown in FIG. 4.

### DESCRIPTION OF PREFERRED EMBODIMENT

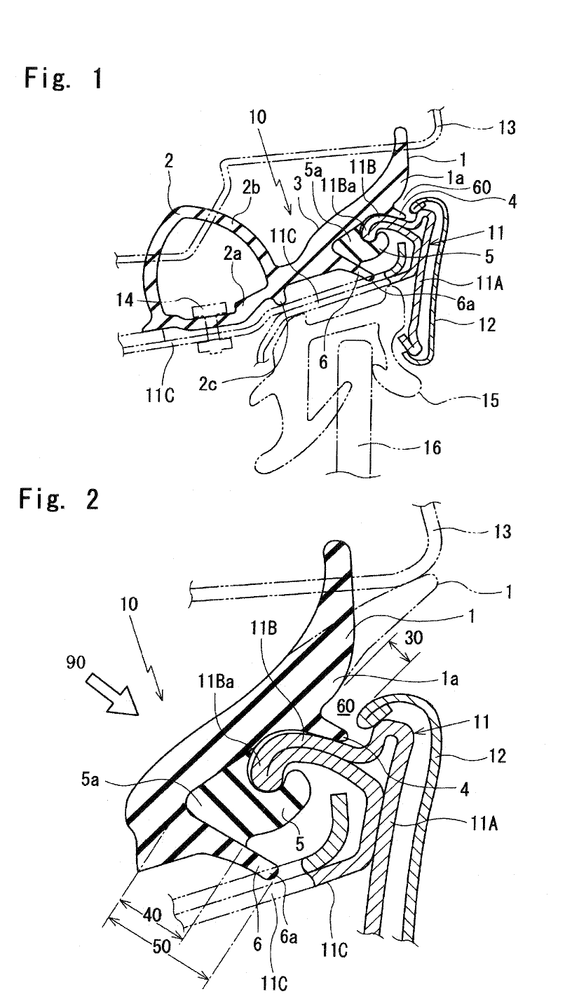

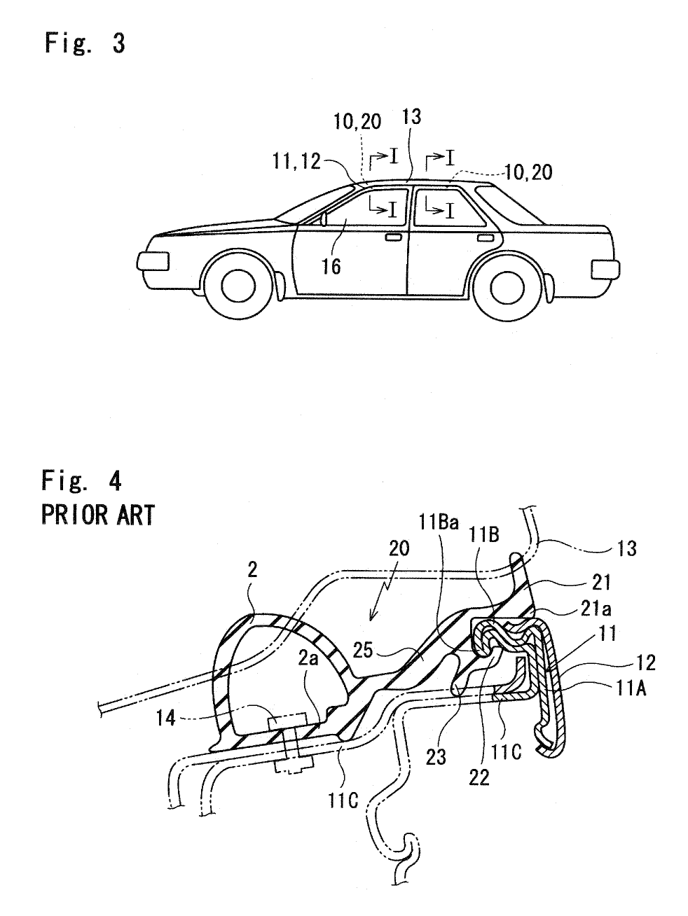

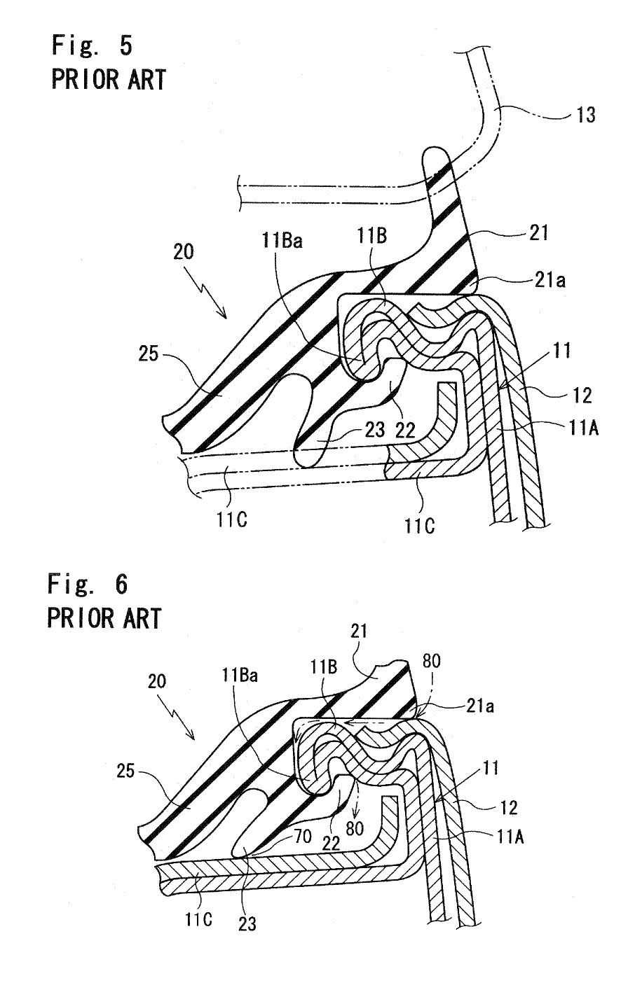

Referring to FIG. 1 and FIG. 2, a door weather strip 10 according to an embodiment of the present invention will be described. FIG. 1 is a I-I line enlarged cross section of FIG. 3, showing a door weather strip according to an embodiment of the present invention and FIG. 2 is a partial enlarged cross section of important parts of the door weather strip shown in FIG. 1. When constituents included in the present invention correspond to those in prior arts, the same symbols are used.

The door weather strip 10 according to the embodiment of the present invention is mounted on a roof side of a door sash 11 of an automobile, said door sash 11 including: an outer surface 11A vertically provided on an outer-cabin side of an upper part of a door; a short first mounting member 11B laterally provided roughly from an upper end of the outer surface 11A toward the inner-cabin side and having a downward anchoring part 11Ba formed on an inner-cabin side end thereof; and a long second mounting member 11C positioned lower than the first mounting member 11B and laterally provided from the outer-cabin side toward the inner-cabin side. Said door weather strip 10 mainly comprises an outer lip 1, a hollow seal member 2, a connecting member 3, a rear lip 4, a hook 5 and a seal lip 6, which are integrally molded.

The hollow seal member 2 has a projection 2c formed on an outer-cabin side end of a base bottom portion 2a thereof in order to improve assembling property and sealing property of the hollow seal member 2 with the second mounting member 11C. A separately molded sash molding 12 made of resin or metal is mounted on the outer surface 11A of the door sash 11 so that the outer surface 11A is covered. A glass run 15 slidably brought into contact with a door glass 16 lifting or lowering is provided just under the door weather strip 10.

A cross-section roughly tongue shaped outer lip 1 roughly vertically extends in an upward direction on an outer-cabin side of said door, a lower part of which as a base root la is positioned higher than the first mounting member 11B. The outer lip 1 is arranged on an inner-cabin side position which is so distant from the outer surface 11A or the sash molding 12, so that an outer-cabin side surface of the outer-lip 1 is arranged on an extension line of a position of roughly ½ in the a lateral direction of the short first mounting member 11B. When the door is closed, a tapered upper part of the outer lip 1 makes an elastic contact with an automobile body panel 13 as described in a two-dot chain line of FIG. 2.

A hollow seal member 2 is arranged on an inner-cabin side compared with the outer lip 1, of which a bottom end as the base bottom portion 2a is mounted on an inner-cabin side of the second mounting member 11C of the door sash 11 by means of a clip 14 and an upper part as a sealing member 2b makes an elastic contact with said body panel 13 in the same manner as said outer lip 1 when the door is closed. It is to be noted that the elastic contact of the hollow seal member 2 with the body panel 13 is made at a lower position than the elastic contact of the outer lip 1 with the body panel 13.

A connecting member 3 connects a base root 1a of the outer lip 1 and an outer-cabin side of the base bottom portion 2a of the hollow seal member 2, and extends diagonally upward from the inner-cabin side toward the outer-cabin side. Length of the connecting member 3 is not precisely limited. In the present embodiment, the connecting member 3 is longer than the outer lip 1 and is roughly of the same length as the length of the base bottom portion 2a of the hollow seal member 2 in the cross-sectional lateral direction. The connecting member 3 is thicker than the sealing member 2b of the hollow seal member 2.

A rear lip 4 provided at a lower position than the base root 1a of the outer lip 1 extends diagonally downward toward the outer-cabin side so as to make an elastic contact with an upper surface of a laterally provided part of the first mounting member 11B of the door sash 11, thereby preventing the entrance of water from a space between the first mounting member 11B and the rear lip 4.

A hook 5 provided at a lower position of the connecting member 3 engages with the anchoring part 11Ba of the first mounting member 11B of the door sash 11 from a lower side while surrounding a side part and a lower part of the anchoring part 11Ba.

The hook 5 made of harder material than any other member of the door weather strip is increased in rigidity and assembling force with the anchoring part 11Ba. In addition, the assembling force of the door weather strip with the door sash is increased for the effect of the structure that the rear lip 4 makes the elastic contact with an upper part of the anchoring part 11Ba and 11Ba is covered with the rear lip 4 and the hook 5.

A seal lip 6 is provided diagonally downward from a bottom end of the base root 5a of the hook 5 toward the outer-cabin side. A top end 6a of the seal lip 6 makes an elastic contact with an upper surface of the outer-cabin side of the second mounting member 11C.

The seal lip 6 is roughly twice as long as the rear lip 4 and is roughly in parallel with the rear lip 4. The seal lip 6 roughly in parallel with the rear lip 4 enables an improved mounting workability of the door weather strip 10 on the door sash, which is carried out while moving the door weather strip 10 diagonally downward from the inner-cabin side toward the outer-cabin side in the direction of an arrow 90 shown in FIG. 2. In addition, the seal lip 6 roughly in parallel with the rear lip 4 prevents reversal of the top end 6a of the seal lip 6 toward the inner-cabin side on the upper surface of the second mounting member 11C of the door sash 11, which causes a complex mounting of the door weather strip 10 on the door sash 11.

Providing the seal lip 6 diagonally downward toward the outer-cabin side prevents occurrence of a space 70 (shown in FIG. 6) between the top end 6a of the seal lip 6 and the door sash 11, where water 80 stagnates for the effect of surface tension. Prevention of occurrence of the space 70 enables smooth release of water 80 entering from the outer-cabin side to the outer-cabin side along the longitudinal direction of the seal lip 6. Such a structure prevents entrance of water 80 to the inner-cabin side, thereby improving the sealing property.

In the present embodiment, length 40 of the base of the hook 5 is longer than ½ of the upper surface width 50 of the seal lip 6 as shown in FIG. 2, which suffices rigidity of the hook 5 and moderately controls elastic deformation of the seal lip 6 so as to increase elastic contact force of the seal lip 6 with the door sash 11.

A gap 60 is provided between the outer-cabin side surface of the base root 1a of the outer lip 1 and the rear lip 4. The gap 60 enables the outer lip 1 along the base root 1a to bend toward the outer-cabin side when the door is closed and the upper part of the outer lip 1 makes the elastic contact with the body panel 13 of the automobile.

The gap 60 is the size sufficient for preventing the outer-cabin side surface of the outer lip 1 from coming into contact with a door side member such as the outer surface 11A of the door sash 11, the first mounting member 11B of the door sash 11 and the sash molding 12 at the time of the elastic contact of the outer lip 1 with the body panel 13. FIG. 2 shows an example of the size of the gap 60, in which an interval 30 between the outer-cabin side surface of the base root 1a of the outer lip 1 and the inner-cabin side of the upper part of the sash molding 12 is roughly as long as the rear lip 4.

Positioning the gap 60 lower than a top end of the sash molding 12 prevents visibility of the gap 60 from the outer-cabin side, thereby improving appearance of the door weather strip.

Providing the gap 60 prevents wrinkles on the outer lip 1 and enables to provide a product excellent in external appearance of the outer lip 1.

More specifically, the body panel 13 and the door sash 11 fasten the outer lip 1 respectively from an upper and a lower side, thereby generating compression force. The compression force is absorbed by the gap 60 where the outer lip 1 along the base root la can more easily bend toward the outer-cabin side compared with a case where the gap 60 is not provided so that the outer lip 1 is not wrinkled.

In addition, the structure that the base root 1a of the outer lip 1 is positioned higher than the door sash 11 via the rear lip 4 and the gap 60 thus provided prevents bottom-abutting that the base root la of the outer lip 1 directly abuts on the door sash 11, therefore, load on the outer lip 1 does not increase. Therefore, the outer lip 1 is not necessarily made of soft material and any material which is not wrinkled and excellent in the external appearance is usable for it.

The door weather strip 10 according to the present embodiment has the outer surface 11A of the door sash 11 covered with the sash molding 12 but the sash molding 12 is not necessarily mounted.

1. A door weather strip mounted on a roof side of a door sash of an automobile, said door sash including: an outer surface vertically provided on an outer-cabin side of an upper part of a door; a first mounting member laterally provided roughly from an upper end of the outer surface toward an inner-cabin side and having a downward anchoring part formed on an inner-cabin side end thereof; and a second mounting member positioned lower than the first mounting member and laterally provided from the outer-cabin side toward the inner-cabin side, wherein:
said door weather strip comprises: an outer lip extending upward on the outer-cabin side of said door, of which an upper part makes an elastic contact with a body panel of said automobile and a lower part as a base root is positioned higher than said first mounting member; a hollow seal member arranged on the inner-cabin side compared with the outer lip, of which a base bottom portion is mounted on the inner-cabin side of said second mounting member by means of a clip and an upper part makes an elastic contact with said body panel; a connecting member connecting said outer lip and said hollow seal member; a rear lip provided at a lower position than the base root of the outer lip and extending toward the outer-cabin side so as to make an elastic contact with an upper surface of a laterally provided part of said first mounting member; a hook provided at a lower position of the connecting member and engaging with the anchoring part of the first mounting member from a lower side; and a seal lip provided downward from a base root of said hook and of which a top end makes an elastic contact with the outer-cabin side of the second mounting member; and wherein a gap is provided between an outer-cabin side surface of the base root of said outer lip and said rear lip, where said outer lip along the base root can bend toward the outer-cabin side at the time of the elastic contact.

2. The door weather strip as claimed in claim 1, wherein:
said gap is a size sufficient for preventing the outer-cabin side surface of said outer lip from coming into contact with a member on said door side at the time of said elastic contact.

3. The door weather strip as claimed in claim 2, wherein:
the member on said door side is one of said door sash and a sash molding mounted on the outer surface of said door sash.

4. The door weather strip as claimed in claim 1, wherein:
said hook is made of harder material than any other member of the door weather strip.

5. The door weather strip as claimed in claim 1, wherein:
said seal lip is provided diagonally downward toward the outer-cabin side.

6. The door weather strip as claimed in claim 5, wherein:
said rear lip is provided diagonally downward toward the outer-cabin side and said seal lip is roughly in parallel with said rear lip.

7. The door weather strip as claimed in claim 2, wherein:
said hook is made of harder material than any other member of the door weather strip.

8. The door weather strip as claimed in claim 7, wherein:
said seal lip is provided diagonally downward toward the outer-cabin side.

9. The door weather strip as claimed in claim 8, wherein:
said rear lip is provided diagonally downward toward the outer-cabin side and said seal lip is roughly in parallel with said rear lip.

10. The door weather strip as claimed in claim 3, wherein:
said hook is made of harder material than any other member of the door weather strip.

11. The door weather strip as claimed in claim 10, wherein:
said seal lip is provided diagonally downward toward the outer-cabin side.

12. The door weather strip as claimed in claim 11, wherein:
said rear lip is provided diagonally downward toward the outer-cabin side and said seal lip is roughly in parallel with said rear lip.

13. The door weather strip as claimed in claim 2, wherein:
said seal lip is provided diagonally downward toward the outer-cabin side.

14. The door weather strip as claimed in claim 13, wherein:
said rear lip is provided diagonally downward toward the outer-cabin side and said seal lip is roughly in parallel with said rear lip.

15. The door weather strip as claimed in claim 3, wherein:
said seal lip is provided diagonally downward toward the outer-cabin side.

16. The door weather strip as claimed in claim 15, wherein:
said rear lip is provided diagonally downward toward the outer-cabin side and said seal lip is roughly in parallel with said rear lip.
